(19) United States
(12) Patent Application Publication
(10) Pub. No.: US 2014/0358524 A1
(43) Pub. Date: Dec. 4, 2014

(54) MACHINE TRANSLATION QUALITY MEASUREMENT

(71) Applicant: REX PARTNERS OY, Espoo (FI)

(72) Inventors: Niko Papula, Espoo (FI); Juha Siivola, Espoo (FI)

(21) Appl. No.: 14/355,927

(22) PCT Filed: Nov. 2, 2012
(86) PCT No.: PCT/FI2012/051073

§ 371 Date: May 2, 2014

(30) Foreign Application Priority Data
Nov. 3, 2011 (FI) 20116084

(51) Int. Cl. G06F 17/28

(52) U.S. Cl. CPC G06F 17/2854; G06F 17/289
USPC 704/9

(57) ABSTRACT

A method, an apparatus, and a computer program for measuring a quality of the machine translation. An original segment, for example one sentence in English, is translated to a target language, for example Spanish. The translated sequence is translated and then back-translated with several machine translation engines back to the original language, for example English. The resulting translations, back-translations are compared, possibly to each other, and to the original sequence. This gives measurement value of the quality of the back translations. At least one measured value from above steps of the process can be used in order to output information about the quality of the machine translation.

### TECHNICAL FIELD

The present invention relates generally to machine translation of a sequence of natural language data. More particularly, the present invention relates to a method, an apparatus, and a computer program for indicating machine translation quality.

### BACKGROUND

Translation from one natural language (human language) to another natural language can be done by a machine translation engine. A machine translation is created by the use of a computer, which automates and performs the translation process. Very often, the machine translation has error or the machine translation is not an exact and correct translation of the original sequence. There are no means to evaluate and measure the machine translation engines for further development. There are also no means to establish metrics for analysing natural language quality, translatability or translation quality.

The original sequence can be translated to the target language and then back translated to the original language. Back translation means translating the sequence from the target language to the original language. The back translation of the sequence can be compared to the original sequence. This process may be regarded as back-translating and comparing to original. This process may output quality information about the quality of the machine translation. However, the process produces bad results, because, for example, double errors. With regard to machine translated data, the used translation training material may contain errors that affect both the translation and back-translation.

Another process for improving the translation is to perform the translation with several different machine translation engines. The translations are then combined, word-by-word, into a combined translation. This may be regarded as translating with several machine translations, and combining the translations word-by-word into a combined translation. This process creates a new translation based on the performed multiple translations. This process is language dependent, and therefore not very suitable for machine translations.

A patent application WO 2006024454 A1 discloses a method for automatic translation, which is not intended to obtaining a quality estimate. It cannot provide a reliable quality estimate due to unreliability of the comparison method involved. The method focusses on selecting the best translation based on best correspondence between the original sequence and the sequence of the back-translation.

A publication “Unsupervised measurement of translation quality using multi-engine, bi-directional translation”, Zaanen and Zwarts, Australia discloses two separate methods for translation quality estimate. The first is based on a one way translation, and the second is based on a multi-engine round trip translation. However, the experiments indicate that unsupervised evaluation, including the round trip translation often used by a layman, is unsuitable for the selection of machine translation systems. The process of comparing only first translations does not give reliable information about translation quality. Furthermore the process comparing only back-translations does not give reliable results. Even when using translations of multiple machine translation systems, to reduce the impact of errors of a single system, a round trip translation cannot be used to more reliably measure machine transition quality. Accordingly, also multi engine roundtrip translation is considered unreliable. A machine translation of even a bit incorrect sentence usually gives very bad translation results. Even good machine translations very often contain small grammatical errors. Therefore, comparing back-translation is more unreliable than comparing first translations. This partly explains why comparing just the back-translations yields unreliable results.

There is a need to overcome one or more of the problems as set forth above.

### SUMMARY OF THE INVENTION

It is an object of the present invention to provide a method, an apparatus, and a computer program for machine translation quality. This object can be achieved by the features defined in the independent claims. Further enhancements are characterized by the dependent claims.

One embodiment is directed to an apparatus, comprising: at least one programmable module configured to cause the apparatus to

receive a sequence of natural language data in a first language;
translate the sequence of natural language data to a second language to define a first machine translation of the sequence of natural language data;
translate the sequence of natural language data to a second language to define a second machine translation of the sequence of natural language data;
back translate the sequence of natural language data of the first machine translation to the first language to define a first machine back translation of the sequence of natural language data;
back translate the sequence of natural language data of the first machine translation to the first language to define a second machine back translation of the sequence of natural language data;
compute a comparison based on the sequence of natural language data in the first language, the first machine translation of the sequence of natural language data, the second machine translation of the sequence of natural language data, the first machine back translation of the sequence of natural language data, and the second machine back translation of the sequence of natural language data; and output a signal representative of the comparison.

One embodiment is directed to a method, comprising:

receiving a sequence of natural language data in a first language; translating the sequence of natural language data to a second language to define a first machine translation of the sequence of natural language data;
translating the sequence of natural language data to the second language to define a second machine translation of the sequence of natural language data;
back translating the sequence of natural language data of the first machine translation to the first language to define a first machine back translation of the sequence of natural language data;
back translating the sequence of natural language data of the first machine translation to the first language to define a second machine back translation of the sequence of natural language data;
computing a comparison based on the sequence of natural language data in the first language, the first machine translation of the sequence of natural language data, the second machine translation of the sequence of natural language data, the first machine back translation of the sequence of natural language data, and the second machine back translation of the sequence of natural language data; and
outputting a signal representative of the comparison.

One embodiment is directed to a computer program, comprising: programmable software codes configured to cause the program to

receive a sequence of natural language data in a first language;
translate the sequence of natural language data to a second language to define a first machine translation of the sequence of natural language data;
translate the sequence of natural language data to a second language to define a second machine translation of the sequence of natural language data;
back translate the sequence of natural language data of the first machine translation to the first language to define a first machine back translation of the sequence of natural language data;
back translate the sequence of natural language data of the first machine translation to the first language to define a second machine back translation of the sequence of natural language data;
compute a comparison based on the sequence of natural language data in the first language, the first machine translation of the sequence of natural language data, the second machine translation of the sequence of natural language data, the first machine back translation of the sequence of natural language data, and the second machine back translation of the sequence of natural language data; and
output a signal representative of the comparison.

An embodiment is configured to measure a translatability quality of original natural language. The embodiment is further configured to measure a quality of a machine translation. Original sequence and several translations and back translations are used in measuring the translation quality so that the embodiment can be language independent. One incorrect back translation or a back translation using different words or phrases does not affect as much. By using original sequence, several machine translations and several machine back translations, a double error can be eliminated. Segments with good or bad translation can be detected. Measurement data obtained at different steps of the process can be combined to output meaningful results to be used for the translation. For example the output from the embodiment can be used to improve translation quality.

At least one of the above embodiments provides one or more solutions to the problems and disadvantages with the background art. Other technical advantages of the present disclosure will be readily apparent to one skilled in the art from the following description and claims. Various embodiments of the present application obtain only a subset of the advantages set forth. No one advantage is critical to the embodiments. Any claimed embodiment may be technically combined with any other claimed embodiment(s).

### BRIEF DESCRIPTION OF THE DRAWINGS

The accompanying drawings illustrate presently preferred exemplary embodiments of the disclosure, and together with the general description given above and the detailed description of the preferred embodiments given below, serve to explain, by way of example, the principles of the disclosure.

FIG. 1 is a diagrammatic illustration of an apparatus configured to measure quality of machine translations according to an exemplary embodiment of the present disclosure;

FIG. 2 is a diagrammatic illustration of an apparatus configured to measure quality of machine translations according to another exemplary embodiment of the present disclosure;

FIG. 3 illustrates an example were one third of machine translations are negative;

FIG. 4 is a diagrammatic illustration of an apparatus configured to measure quality of machine translations according to another exemplary embodiment of the present disclosure;

FIG. 5 is a diagrammatic illustration of a part of the machine translation evaluation apparatus according to another exemplary embodiment of the present disclosure; and

FIG. 6 is a diagrammatic illustration of a general purpose computer of the apparatus according to an exemplary embodiment of the present disclosure.

### DETAILED DESCRIPTION

According to one embodiment of the invention, an original segment, for example a sentence in English, is translated to a target language, for example to Spanish, in some way, for example by a machine translation. It's difficult to estimate the quality of the translation by comparing the original and the translation in the target language, especially because they are in different languages.

It is possible to translate the translated sequence back to the original language, English in this example. This is referred to as back-translating. Then this can be compared to original more easily because they are both in the same language. However, this does not give reliable results because:

A. Back-translation itself is unreliable. It might have been translated incorrectly and therefore the results are unreliable.
B. If the back-translation is correct, it might use different words to express the correct meaning. That is, it is possible to express the same thing with several different sentences. The comparing methods (similarity measures) typically rely at least partially on detecting same words in both original and the compared text. Therefore comparing the original to back-translation does not give reliable results.

The embodiment of the invention uses original sequence, at least two or several translations and back-translations to overcome the above mentioned problems. When the comparison is based on the original sequence, at least two or more translations and back-translations, one incorrect translation, back-translation, or one translation or back-translation using different wording, does not affect as much. It is usual, that at least some translations and back-translations are translated correctly and use the same words as the original. Therefore the comparison is much easier and the results are much more reliable.

Comparison can be based on original sequence translations and back-translations. This gives much more information and measurement results than using only one back-translation or only (first) translations. By utilizing the comparison of the (first) translations, the embodiment of the invention can detect some of the bad first translations and omit them from the comparison or at least give them a lower weight in the comparison.

1) Two or more (first) translations can be compared to each other according to an embodiment of the invention. For example all (first) translations can be compared to each other. 2) Two or more back translations of one of the (first) translations can be compared to original sequence according to an embodiment of the invention. The results of these comparisons can be combined to analyse the quality. 3) Two or more back translations of one of the (first) translations can be compared to each other according to an embodiment. The results of these comparisons can be combined to analysing the quality. 4) Two or more back translations of different (first) translations can be compared to each other according to an embodiment of the invention. For example all back translations can be compared to each other. The results of these comparisons can be combined to analyse the quality. 5) Two or more back translations of different first translations can be compared to the original sequence according to an embodiment of the invention. The results of these comparisons can be combined to analyse the quality.

When there are several translations and back-translations, an exemplary embodiment of the invention use statistical methods for improving the comparison. This is not possible when comparing just one back-translation.

An embodiment of the invention can use additional measurement points of the process to increase accuracy of the quality measurement. For example in an embodiment of the invention, the most suitable translation or back-translation is compared to the original sequence. This gives further measured values. The additional measurement points can, for example, be characteristics of the original sequence in the first language, use of auxiliary language, several translations (in addition to several back translations), and repetition of the process.

An embodiment of the invention can help reducing translation costs, for example by filtering out bad translations and detecting good translations. The embodiment of the invention can output feedback so that the original sequence can be edited to be better translated by the machine. More accurate price quotes for translations can be given on a basis of how difficult the text is to translate. The quality measurement values can be used to develop machine translation engines.

In a further embodiment the quality measurement process can be performed online. For example translatability of the text can be measured during writing, for example by Word macros.

A translation segment is typically one sentence, for example a sentence in English. The translation segment may be a part of a sentence. Several segments together may form the whole text.

Translation quality can be defined as understandability of a translation. Translatability describes how easily human produced text can be machine translated or human translated to different languages. The reader should understand correctly the meaning of the translated sentences.

Match in multiple machine translations describes how unanimous various machine translation engines are. If engines are unanimous, then the translation is probably good. Match can describe the probability that a translation is good.

Trigram (or N-gram) distance describes how similar two data strings are. For example if a trigram distance between original and back-translation is small, then the translation is probably good.

When comparing segments, various applicable measurement methods can be employed. It's possible to include parameters that give different weights to different machine translation engines/translations.

It should be noted that one machine translation engine can sometimes give more than one translation. For example a machine translation engine having a plurality of different parameters and/or different configurations may perform a plurality of different translations.

Known translation quality methods use very simple translation processes. They do not form an advanced process that can contain a combination of forward-translation and back-translation. Also they typically do not use several measurement points in several, different parts of the process, even the simple process. An exemplary embodiment of the invention uses a translation process with several measurement points in different parts of the process. This combination yields essentially better results than competing methods.

Known methods are statistical. Known solutions use e.g. following variables:
percentage of trigrams in quartile 1 (lower frequency words) of frequency of source words in source MT-training data
average length of source phrases
target syntax features based on relative frequency of a POS tag in the segment

The known methods are statistical by nature. These and other variables are being used statistically, that is as a general indication of the translation quality of a sentence of certain type. That is, they are not used to compare source and target sentences but as a general indication of how difficult a sentence with certain characteristics is to translate.

An embodiment of the invention can directly compare the source and target sentences. Therefore it is not a statistical method. However, it can additionally use also statistical variables in the comparison.

Known methods are language-dependent and use variables or similarity measurement known methods that are very much dependent on the language, either source or target language. This makes the known methods language-dependent.

An exemplary embodiment of the invention uses variables or similarity measurement methods that are language independent. That is, it uses variables or similarity measurement methods that do not depend on either source or target language. Therefore the embodiment of invention is language-independent. However, the embodied invention can use also language-dependent variables or similarity measurement methods additionally.

An embodiment of the invention relates to combining simplification engine with a machine translation process. Typically the content of a text can be written in several ways. For example, the author may choose to write, for example, long or short sentences. The quality of machine translation varies greatly based on how difficult the source text is. For example, if the source text contains long sentences and complex sentence structures, its machine translation will be bad. If a text containing the same content is written with simpler sentences, its machine translation will be better.

For some languages there are tools that automatically simplify a text, so-called simplification engine. This kind of tool receives sentences as input. The tool's output contains simpler sentences that contain the same information as the input.

An embodiment of the invention combines the simplification engine with a machine translation process of the embodied invention. In the combination, the simplification engine first simplifies the text which is then fed into the machine translation system. This results in better translation quality.

An embodiment of the invention uses customized machine translation engines. One method for improving machine translation quality is to customize machine translation engine for a certain purpose. For example, machine translation engine can be customized to translate certain words in a certain way that is suitable for the chosen purpose. This kind of customized machine translation engines are being used e.g. in airplane industry.

Because an exemplary embodiment of the invention uses a translation process, which includes a use of several machine translation engines at the same time, customizing the whole system would require customizing several machine translation engines. This may be both expensive and time-consuming. An embodied invention includes also the following method that can be used to combine customized machine translation engine and a translation process.

Some machine translation engines are able to output a quality indication, together with a translation. This quality indication is called a confidence estimate. The confidence estimate can be used to determine whether the customized engine was able to translate the sentence well. For example, if the confidence estimate is low, the customized engine was not able to translate the sentence well and therefore an advanced translation process should be used. If the confidence estimate is high, then an advanced translation process might not be required.

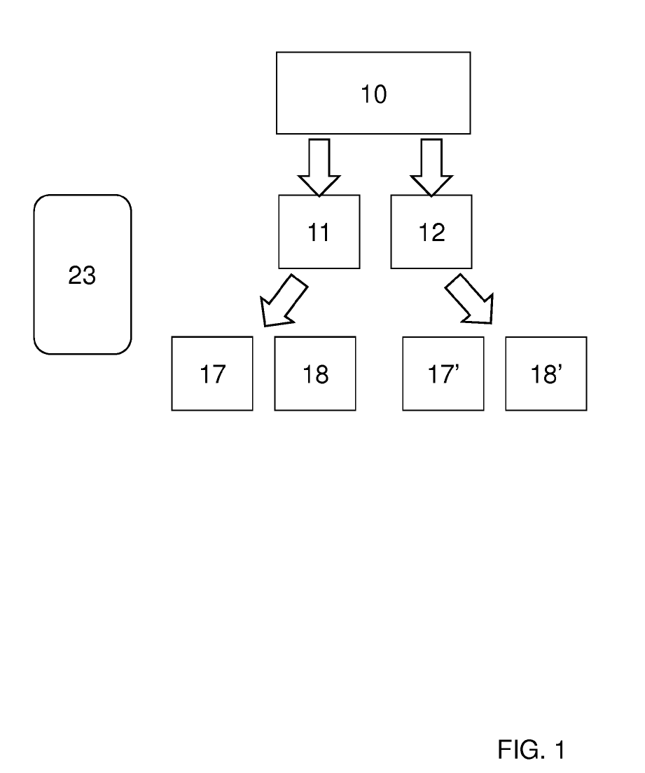

Referring to FIG. 1, there is a diagrammatic illustration of an apparatus for measuring quality of the machine translations according to an exemplary embodiment of the present invention. The apparatus comprises programmable blocks or modules that are configured to perform various operations. In block 10, the apparatus receives an original segment of a natural language. A data representation of the segment is accordingly received or created. In blocks 11 and 12 the original segment is translated by two ore more machine translations, MT, engines to a target language. Block 11 is configured to perform the first machine translation. Block 12 is configured to perform the second machine translation.

The apparatus is configured to perform the back-translation by two or more machine translation engines, as illustrated by blocks 17 and 18. FIG. 1 has two MT engines but it should be noted that only two is needed as a minimum. The sequence is translated back to its original language, for example English. Block 17 is configured to back translate the translated sequence of the block 11. Block 18 is configured to back translate the second back translation of the translated sequence of the block 11. Block 17′ is configured to back translate the translated sequence of the block 12. Block 18′ is configured to back translate the second back translation of the translated sequence of the block 12. The apparatus is configured to perform a comparison based on original sequence, at least two translations and at least two back-translations in a block 23.

For example the block 23 can be configured to compare two translations received from blocks 11 and 12. Block 23 can be configured to compare two back translations received from block 17,18 to original sequence received from block 10. Block 23 can be configured to compare two back translations received from block 17,18 to each other. Block 23 can be configured to compare two or more back translations 17,17′ of different (first) translations to each other. For example all back translations received from block 17,18,17′,18′ can be compared to each other. Block 23 can be configured to compare two or more back translations of different first translations received from block 17,17′ or 18,18′ to the original sequence of block 10.

The results of these comparisons can be combined to analyse the quality in various combinations. The comparison block 23 is configured to give measured values about the quality of the translations and any possible translation problems within it.

The blocks 11, and 12 and 17 (correspondingly 18, and 17′,18′) illustrate different machine translation engines or different configuration of a machine translation engine. They may be the same machine translation engines performing the translation and the back-translation. Also although two translation engines and two back machine translation engines has been illustrated by the block 11,12,17,18, as an example, it should be noted that there can be a different number of machine (back) translation engines starting from two to a various number of machine (back) translation engines.

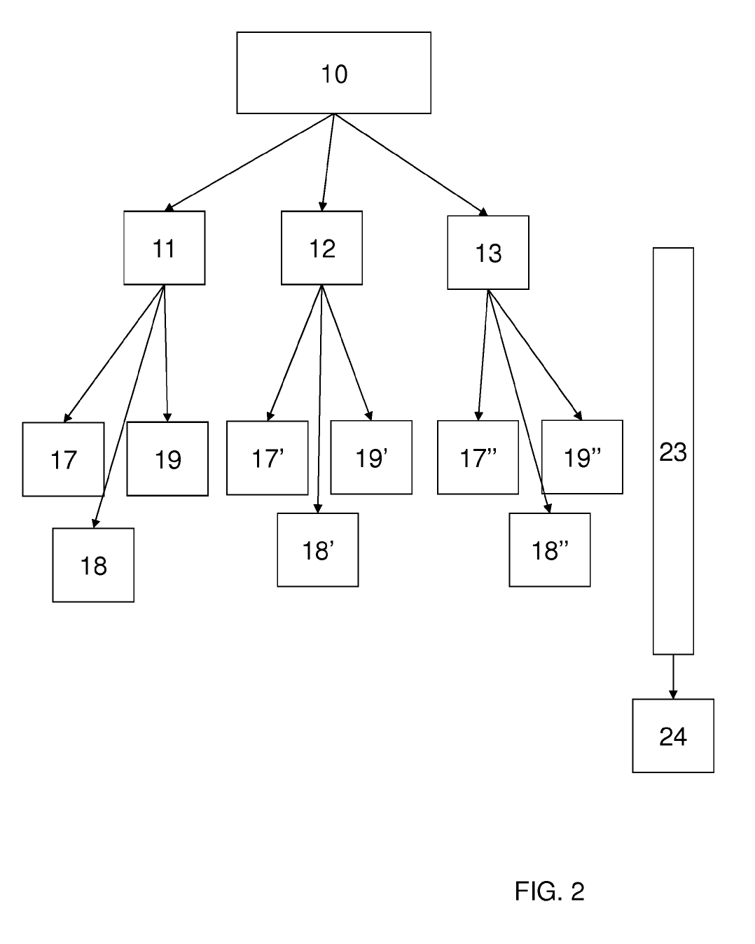

Referring to FIG. 2, there is a diagrammatic illustration of an apparatus for measuring quality of the machine translations according to an exemplary embodiment of the present invention. The apparatus comprises programmable blocks or modules that are configured to perform various operations. In block 10, the apparatus receives an original segment of a natural language. A data representation of the segment is accordingly received or created. In block 11, 12, and 13, the original segment is translated by a plurality of machine translation, MT engines, to a target language. The example of FIG. 1 has three MT engines blocks 11,12,13 configured to perform the translation. The MT engine blocks 11,12,13 are different translation engines. In one embodiment they may have a different configuration and/or parameters etc.

The apparatus is configured to perform the back-translation by several MT engines, as illustrated by blocks 17,18,19. The example has three back translation engines. The sequence is translated back to its original language, for example English. The back translation blocks 17,18,19 are configured to back translate the translated sequence of the translation block 11. There are three back translations made accordingly. Similarly back translation blocks 17′,18′,19′ are configured to back translate the translated sequence of the translation block 12. Similarly back translation blocks 17″,18″,19″ are configured to back translate the translated sequence of the translation block 13. From each translation of the plurality of translations, a plurality of back translations can be established.

In the embodiment of FIG. 2 several values can be measured and compared. There are various different possibilities how to collect the comparison data and how to compare them. Block 23 is configured to receive the data and perform the comparison. Block 23 is configured to perform the five comparison examples described with respect to FIG. 1. For example, comparing the translation of block 11,12,13 to each other gives information about the quality of the translations. Also comparing the back translations of block 17,18,19 to the original sequence of block 10 gives information about the translation quality. Also comparing the back translations of blocks 17′,18′,19′ to each other gives information about the translation quality. Also comparing the back translations of all blocks 17,18,19,17′,18′,19′,17″18″,19″, to each other (i.e. comparing all back-translations to each other) gives information about the translation quality. There are several possibilities to perform the comparison of the block 23.

Block 24 is configured to combine all the information and comparison and measurement results obtained in the embodiment of FIG. 2 from the block 23 for resulting in better estimates of translation quality of each translation and back-translation. By combining information from several sources, block 24 is may be further configured to reduce or cancel the effect of incorrect machine translations and incorrect comparison and measurement results. Block 24 is configured to perform the combination of the comparison results in various ways. For example option 1) and 3) can be combined, options 1), 2) and 3) can be combined. Options 1) and 2) can be combined or 2) and 3) combined. Furthermore it can be supplemented by option 4) and/or 5). Any combination of comparison options 1), 2) 3), 4) and 5) is available.

An embodiment of the invention relates to modifications of blocks 23 and 24, in which combining the information and comparison and measurement results from several sources enables statistical handling of the results. Block 24 comprises statistical computing block. With the use of the statistics, block 24 can obtain more reliable estimate of translation quality. The reliable quality estimate can, for example be used for selecting the best of translation of the MT engines 11, 12, and 13.

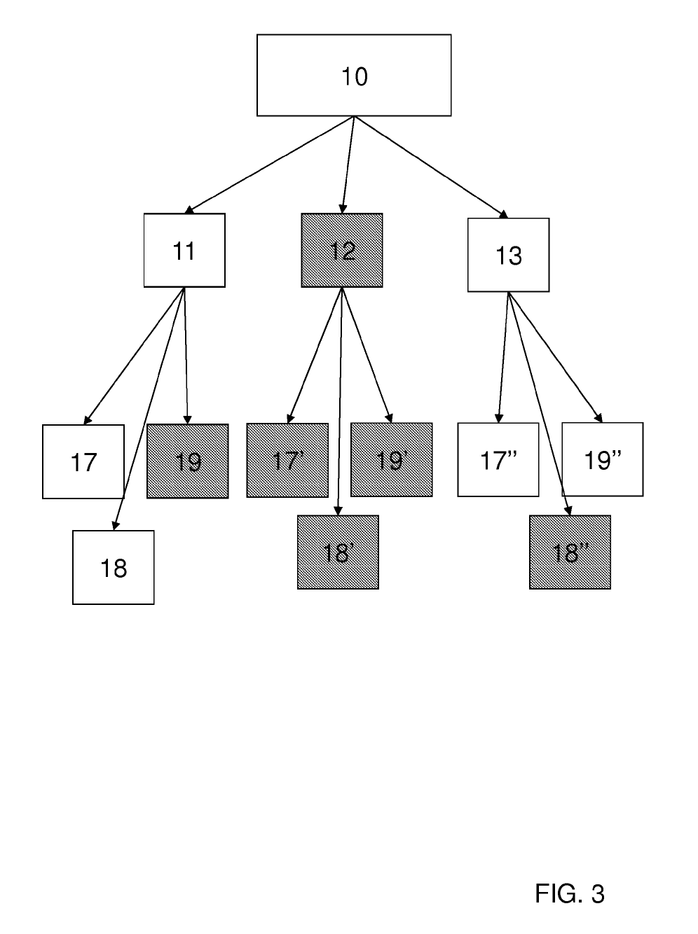

FIG. 3 illustrates an example of the embodiment of the invention where there is being assumed that one third of machine translations are bad. Two thirds of machine translations are good. Good translations are illustrates as being (or resulting from) white blocks, 10,11,13,17,18,17″,19″. Bad translations are illustrated as being (or resulting from) grey blocks 12,19,17′,18′,19′,18″. For example, comparing all back translations and the original sequence to each other as in the known technology would means comparing original sequence, four good translation sequences and five bad translation sequences. This quite obviously gives very unreliable results, because the majority of the back translations are bad in this example.

Selecting translations enables to radically reduce the effect of negative back translations. In an alternative embodiment, the translations and their back translations may be given different weights in the comparison process. In the example of FIG. 3, the apparatus can compare original sequence 10, four good back translations 17,18,17″,19″ and two bad back translations 19′,18″. This yields better results in this example. Furthermore, translations 11,12,13 can be also used in the comparison that additionally improves results.

The measurements in different part of the process give versatile information about the translation quality. In this way it is possible to reduce and cancel effects of both unreliable measurements and also measurements from those points that are unsuitable in certain situations. In that way the translation quality estimates are more reliable. The large number of measurements also opens possibility to use statistical methods, for example filtering out unreliable results.

According to an embodiment of the present invention, an original segment, for example a sentence in English, is translated with many machine translation engines to a target language, for example Spanish. The most suitable translation is chosen from these translation.

The most suitable translation is back-translated with several machine translation engines to the original language, for example English. The most suitable back-translation is chosen. The most suitable back-translation is compared to the original sequence. This gives measured value of quality of the machine translation.

At least one measured value from above steps of the process is processed and used in order to output information about the quality of the machine translation. In further embodiment there may be several measured values that are used for outputting information about the quality of the translation.

In an embodiment the machine translations from the original sequence to another language are compared to each other. This gives further measured value of quality of the machine translations, for example how close the translations are to each other. The selection can be performed based on the measured values.

In an embodiment, the resulting back-translations are compared to each other. This gives a measured value of the quality of the back translations. The selection can be performed based on the measured values

The most suitable translation can be selected and the comparison can be based, for example, on measuring distances of the translation to each other. This can be carried out by using known ways of measuring the distances of the machine translations (MT). For example MT1 has a distance of 130, MT2 70, MT3 85 and MT4 130. In this case the most suitable is MT2 because an average distance to other translation has most suitable value. Other known ways, than the distance measurement, for measuring the quality of the translation to can be used as well. The same process applies for the back translations, wherein the distances of the back translations can be measured to each other. The measurement results can be combined with each to have an overall value indicative of the quality.

The most suitable, or the best, translation can be selected to be applicable for the user. The user is able to use it. This can be in addition to the measured value, which the process can output. The measured result is directed to the selected most suitable translation, but the quality feedback can be outputted for the other translation additionally.

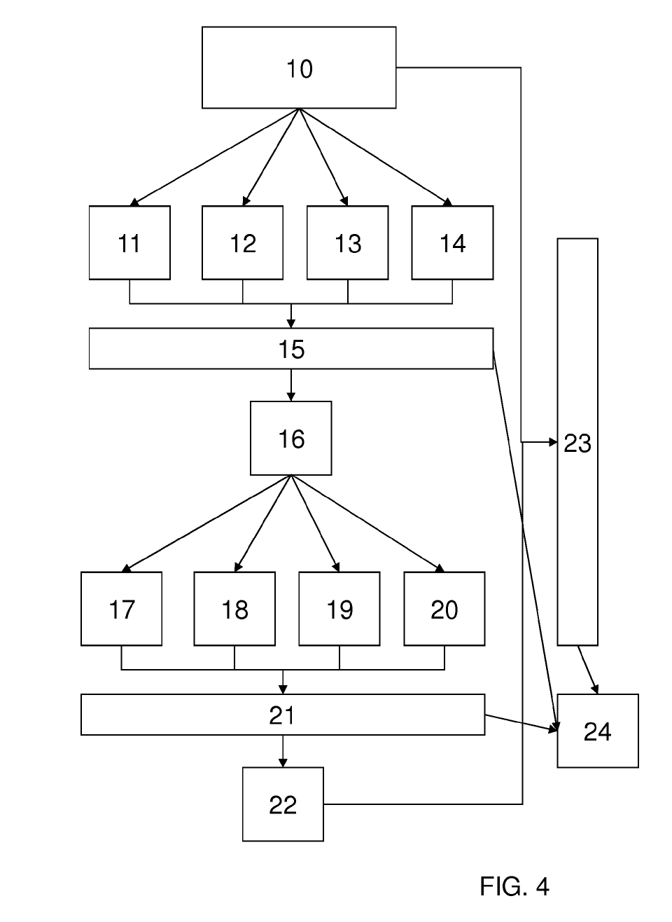

Referring to FIG. 4, FIG. 4 is a diagrammatic illustration of an apparatus configured to measure quality of machine translations according to an exemplary embodiment of the present disclosure. The apparatus comprises programmable blocks or modules that are configured to perform various operations. In block 10

Referring to FIG. 4, there is a diagrammatic illustration of an apparatus for measuring quality of the machine translations according to an exemplary embodiment of the present disclosure. The apparatus comprises programmable blocks or modules that are configured to perform various operations. In block 10, the apparatus receives an original segment of a natural language. A data representation of the segment is accordingly received or created. In blocks 11, 12, 13, and 14, the original segment is translated by a plurality of machine translation, MT, engines to a target language. The example of FIG. 4 has four different MT engines blocks 11,12,13,14 configured to perform the translation. The MT engine blocks 11,12,13,14 are different translation engines. In one embodiment two or more may be the same translation engine having a different configuration and/or parameters.

The resulting several translations are compared to each other in block 15. The block 15 is configured to output a measured value (measurement value). The measured value gives a measured value of a quality of the machine translations. The measured value evaluates the machine translation. For example, the different measured values may indicate how close the machine translations are to each other.

The apparatus is configured to select the most suitable translation in block 16. The selection may be based on the measured values obtained by the block 15. The selected translation is back-translated. The apparatus is configured to perform the back-translation by several machine translation engines, as illustrated by blocks 17,18,19, and 20. The sequence is translated back to its original language, for example English. The apparatus is configured to compare the resulting back-translations to each other by the block 21. The block 21 is further configured to output measured values of the quality of the back-translations. For example how close the back-translations are to each other. The configuration of block 21 is similar, but not necessarily identical, to the configuration of block 15. For example there may be a different number of machine translation engines in the back translation process for the block 21 than for the translation process for the block 15 etc. The block 22 is configured to select a back-translation. For example, the block 22 may be configured to select the most suitable back-translation. The block 22 may be configured to perform the selection based on the measurement values, which are provided by the block 21.

The apparatus is configured to compare the selected back-translation to the original in a block 23. The block 23 is configured to compare the original sequence to the sequence received from the block 22, the sequence of the back translation. This gives further measured values.

The apparatus may comprise a block 24 configured to combine the measured values. The block 24 is configured to collect the measured values and process them. Combining the measured values from the blocks 15,22,23 results in an overall measurement of the machine translation quality. Thereby the apparatus is configured to evaluate the quality of machine translations.

The blocks 11 and 17 (correspondingly 12 and 18, 13 and 19, 14 and 20) illustrate different machine translation engines or different configuration of a machine translation engine. They may be the same machine translation engines performing the translation and the back-translation. Also although four machine translation engines has been illustrated by the block 11,12,13,14 as an example, it should be noted that there can be a different number of machine translation engines starting from two to a various number of machine translation engines.

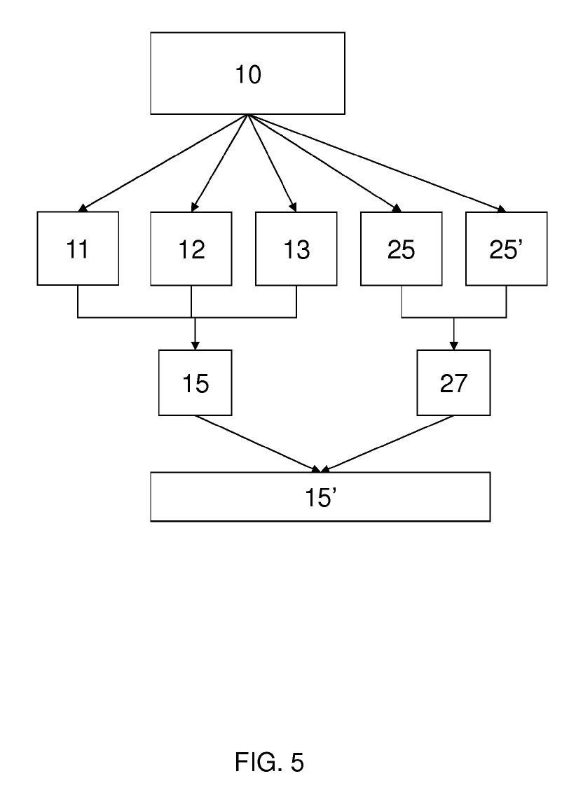

Referring to FIG. 5 an alternative embodiment of the present invention is illustrated. The translations and back-translations, and their corresponding engines can be used in several ways. For example, an embodiment of the invention may use translations to one or more auxiliary languages. An auxiliary language may be a language which is not an original or a target language. It should be noted that the auxiliary language can be a natural language or an interlingua. FIG. 4 illustrates two machine translation engines, blocks 25 and 25′, configured for different language(s) than the machine translation engines illustrated by blocks 11,12,13. Block 15 of the apparatus in FIG. 4 is configured to perform the operation of block 15 in FIG. 1. Block 27 illustrates a possible further machine translation engine configured to perform a further machine translation to the sequence. For example original sequence is in Spanish and block 11,12,13 perform translation into English. Blocks 25 and 25′ perform the translation Spanish to French (25) and Spanish to German (25′). Block 27 is configured to perform a further translation into English.

Block 15′ of the apparatus is accordingly configured to compare the translations to each other, for example as discussed in the embodiments of FIGS. 1,2, 3 and 4.

Although the exemplary embodiment of FIG. 5 only illustrates a translation from the original sequence to a target language, the exemplary embodiment is applicable to the back translation process as well (for blocks 16-21 of FIG. 1) The process of FIG. 4 can be repeated several times to one or more chosen translations/back-translations.

The embodiment of FIG. 5 can use more than one auxiliary language as long as the auxiliary languages are finally translated to the common second language. For example, a first auxiliary language may be French, a second may be German and finally English.

Various different known measuring ways can be used to produce measurement values or measured values of the translations. Some of them are described here as an example.

A. Trigram (or N-gram as a generalization of trigram)
B. Levenshtein (edit-distance, on character level)
C. Word error rate (corresponds to word-level Levenshtein)
D. METEOR (as a development of BLEU and NIST)

### E. Stanford Natural Language Parser

F. weighted trimgram (or N-gram)

### H. TINE

The measurement means are in the blocks 15, 21 and 23 of FIG. 1,2,3, 4. Accordingly the apparatus is configured to measure the quality of the translation in these blocks by using these measurement units. Although only seven measurement ways are identified, the invention can apply various measurement processes to output a quality of the translation, and apply it to combine the measurements in the processes and blocks of the apparatus to output an overall measurement of the quality of the translation.

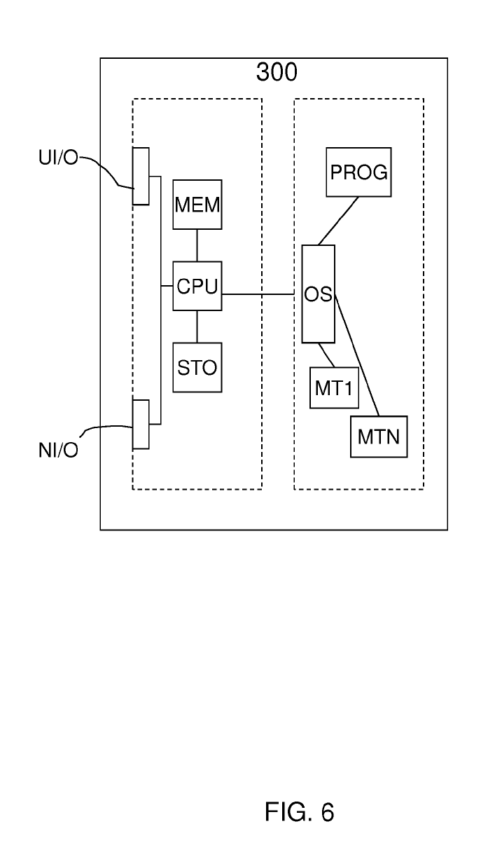

FIG. 6 illustrates a general purpose computer 300 of the apparatus, which is configured to carrying out the operation of the embodiments of FIGS. 1 and/or 2.

The general purpose computer 300 includes hardware HW and software SF. The hardware HW comprises a processor CPU, memory MEM (ROM, RAM, etc.), persistent storage STO (e.g., CD-ROM, hard drive, floppy drive, tape drive, etc.), user I/O, and network I/O. The user I/O 122 can include a camera, a microphone, speakers, a keyboard, a pointing device (e.g., pointing stick, mouse, etc.), and the display. The network I/O may for example be coupled to a network such as the Internet. Interfaces I/O or the storage STO can be used in downloading the sequence of natural language into the apparatus. The software SF includes an operating system OS, machine translators MT1 . . . MTN, and a program PROG. The machine translators MT1 . . . MTN can be different machine translation engines and/or a single (or multiple) engine configured with different parameters or configurations. The program PROG is configured to perform the operations of the embodiments of FIGS. 1, 2, 3, 4 and 5.

Exemplary use scenarios are listed below. These effects may be achieved by one or more of the embodiment mentioned. This results in that the method, apparatus, or program can achieve these effects rather than only by human intervention.

Use Case A. Cutting Translation Cost

Machine translation may increase or decrease translator's productivity.

If the translations are good, the productivity naturally increases. If the translations are bad, then editing a bad translation will take more time than re-translating the segment by a human or a machine. Therefore it is good to measure the translation quality in a reliable way.

In a typical translation process the segment-to-be-translated is first compared to existing translation memories. Good matches are then automatically inserted by the translation memory. The human translator checks and, if necessary, also edits them. Human translator also translates the untranslated segments.

Machine translation with quality estimates fits the typical translation process well. Together with quality estimation it can be used to create better matches. From the process point of view, good machine translations are equal to good matches from the translation memory. Therefore, machine translation with quality estimation fits the existing translation processes seamlessly.

For the segments found in the translation memory the translator typically receives a lower price than for a completely new translations. Therefore the mechanism for saving cost by good translations already exists. The better the machine translation quality, the bigger the cost savings are. This can provide lower translation costs.

Also machine translators can be better accepted among human translators, who need less fixing for bad translations.

Use Case B. Quoting Translation Prices According to Translation Complexity

By estimating machine translation quality per each text the translation service provider can adjust its quotes per text. For example, if the text is difficult to translate the quoted price should be higher. If the text is easy to translate, the price could be lower or the profit higher. With a translation quality estimation, the translation service provider has an easy way to estimate its expected translation cost and thus can adjust its quote accordingly. This can result in more accurate quotes further resulting in higher profit.

Use Case C. Estimating Translatability During Writing

The author of a text to be translated can be informed of how easy his text is to translate. If the text is difficult to translate, he can edit the text to be easier to translate. It's possible to give feedback to an author about how to edit the text (for example suggest different vocabulary).

In many cases it is possible to achieve 100% translatability, that is, 100% of the text can be translated by a machine and with good quality.

This opens completely new markets. Currently translatability can not be measured in a very reliable way. Thus authors typically do not know how to write easily translatable text. However, with proper feedback it is relatively easy to do that.

Once the source language text is verified to be easily translated with single or multiple language pairs, it can be easily translated to any new language, thus resulting new magnitude of the cost savings.

For example. “Simple English Wikipedia” contains articles written in simple language so that it is easier to understand. Imagine translating these articles automatically to other languages, with sufficient quality. This example can give a higher translation speed.

Use Case D. Reducing Required Skill Level

This may require a very high translation quality. Usually translating text from language A to B requires at least some work form a person that understands both languages A and B. However, with translation quality estimation this may not be longer the case.

With proper feedback from quality measuring, the author may be able to write text that a machine can translate correctly to another language. Although the meaning can be understood correctly, the style and correctness of the language is not perfect. The language style and correctness can be edited by a person who does not need any skill in the original language.

Use Case E. Developing Machine Translation Engines

A reliable machine translation quality estimation is useful in developing better machine translation engines. It is generally known that the accuracy of current quality evaluation methods limits the development of a machine translation.

Use Case F: Categorized Measurements

The categorization of each sentence by, for example a colour or a number, can be performed to describe the result of the automatic quality estimate. For example 1 means verified good translation quality, 2 means medium quality, 3 means that either the quality is bad or it could not be estimated. In this context, quality is defined as understandability. That is, the quality is good if the meaning of the sentence is understood correctly. The output of the apparatus can be configured to categorise the translation according to the level of the quality of the translation.

This process can be repeated to improve the original text in order to get better machine translations.

Sample 1. Result of back-translation with quality estimation. The original of this text was written so that it could be translated easily by a machine. That is, text is written in a way to be easily translated by the machine.

1: “We are developing a service that estimates the quality of machine translation. We have presented the idea to several potential customers and also to the researchers of the University.” 2: “Based on the information we received, there is demand for this service and there is no publicly available for this service.” 1: “Therefore we think that the potential for this service is excellent. The service is based on several commercial and technological ideas.” 2: “It includes to combine several technical characteristics in an innovating way.” 1: “We have also found several excellent ways to commercialize the service.”

Sample 2. Result of back-translation with quality estimation. The original of this text was written with only some attention paid to the translatability. That is, the guidelines for easy translatability were only partially followed. 1: “The automatic translation is a fast developing technology that will change the world.” 3: “It will allow the communication in real time between the people who would not be understood of another way.” 2: “It is public—machine translation services available, free easy to use and translate the text into other languages. However, the automatic translation incurs very bad mistakes sometimes.” 3: “This of course causes distrust in the automatic translation and avoid the people to use.” 2: “In this way you can avoid errors of translation with machine translation, even if the translations are correct 99% of the time. Our service detects the errors and reduce them.” 1: “Therefore, people will be able to know when to rely on machine translation.” 2: “This greatly increases the chances that you can use the automatic translation. An important advantage of the service will be of feedback for the authors. When the author has knowledge on if the text is easy to translate or no, it will be able to modify its text. Thus, a described author will be able to write text that can be translated of machine.” 1: “Obviously this reduces translation costs and increases the speed of communication.”

Sample 3. Result of back-translation with quality estimation. The original text was edited from sample 2, to improve its translatability. This has a positive effect on the quality.

1: “Automatic translation is a fast developing technology that will change the world. It will enable communication in real-time between persons who do not have a shared language. It is very easy to translate text into other languages with free machine translation services.” 2: “However, automatic translation sometimes makes big mistakes. This naturally leads to distrust of machine translation and prevents people using it. Therefore, translation errors can prevent the automatic translation, although the translations are correct 99% of the time.” 1: “Our service detects errors and reduce them. Therefore, people will know when to rely on machine translation. This greatly increases the chances that machine translation is useful. An important advantage of the service is feedback to the authors. Author can edit the text if it is difficult to translate. Thus, the author can write a text that can be translated by a machine. Obviously this reduces translation costs and increases the speed of communication.”

It will be apparent to those skilled in the art that various modifications and variations can be made to the apparatus and method. Other embodiments will be apparent to those skilled in the art from consideration of the specification and practice of the disclosed apparatus and method. It is intended that the specification and examples be considered as exemplary only, with a true scope being indicated by the following claims and their equivalents.

1-34. (canceled)

35. An apparatus, comprising: at least one programmable module configured to cause the apparatus to receive a sequence of natural language data in a first language;
translate the sequence of natural language data to a second language to define a first machine translation of the sequence of natural language data;
translate the sequence of natural language data to the second language to define a second machine translation of the sequence of natural language data;
back translate the sequence of natural language data of the first machine translation to the first language to define a first machine back translation of the sequence of natural language data;
back translate the sequence of natural language data of the first machine translation to the first language to define a second machine back translation of the sequence of natural language data;
compute a comparison based on the sequence of natural language data in the first language, the first machine translation of the sequence of natural language data, the second machine translation of the sequence of natural language data, the first machine back translation of the sequence of natural language data, and the second machine back translation of the sequence of natural language data; and
output a signal representative of the comparison.

36. The apparatus according to claim 35, wherein the comparison is configured to be computed based on statistical methods.

37. The apparatus according to claim 35, wherein the comparison is configured between the first and the second machine translations.

38. The apparatus according to claim 35, wherein the comparison is configured between the first and the second machine back translations.

39. The apparatus according to claim 35, wherein the comparison is configured between the first and the second machine back translations and the sequence of natural language data.

40. The apparatus according to claim 35, wherein the apparatus is further configured to compare the first machine translation and the second machine translation and select one of the first or the second machine translation so that said comparison is based on the selected one of the first or the second machine translations and the first and the second back translations.

41. The apparatus according to claim 35, further being configured to back translate the sequence of natural language data of the second machine translation to the first language to define a third machine back translation of the sequence of natural language data of the second machine translation.

42. The apparatus according to claim 41, further being configured to back translate the sequence of natural language data of the second machine translation to the first language to define a fourth machine back translation of the sequence of natural language data of the second machine translation.

43. The apparatus according to claim 42, wherein the comparison is configured between the first, the second, the third and the fourth machine back translations.

44. The apparatus according to claim 42, wherein the comparison is configured between the first, the second, the third and the fourth machine back translations and the sequence of natural language data.

45. The apparatus according to claim 41, wherein the comparison is configured between the first and the third machine back translations.

46. The apparatus according to claim 35, further being configured to combine data of the comparisons.

47. The apparatus according to claim 35, further being configured to select one of the first or second machine translation of the sequence of natural language data.

48. The apparatus according to claim 47, further being configured to back translate the selected sequence of natural language data to the first language to define the first machine back translation of the sequence of natural language data;
back translate the selected sequence of natural language data to the first language to define the second machine back translation of the sequence of natural language data;
select one of the first or second machine back translation of the sequence of natural language data;
compute the comparison between the sequence of natural language data in the first language and the selected machine back translation of the sequence of natural language data.

49. The apparatus according to claim 35, wherein the apparatus is further configured to compute a preliminary comparison between the first and the second machine translation of the sequence of natural language data and value; or the apparatus is further configured to compute a preliminary comparison between the first machine translation of the sequence of natural language data and a value.

50. The apparatus according to claim 49, wherein the apparatus is configured to perform the selection of one of the first or second machine translation of the sequence of natural language data on a basis of the comparison.

51. The apparatus according to claim 35, wherein the apparatus is further configured to compute a preliminary comparison between the first and the second machine back translation of the sequence of natural language data; or wherein the apparatus is further configured to compute a comparison between the first machine back translation of the sequence of natural language data and a value.

52. The apparatus according to claim 51, wherein the apparatus is configured to perform the selection of one of the first or second machine back translation of the sequence of natural language data on a basis of the comparison.

53. The apparatus according to claim 35, wherein the signal is configured to provide an indication of the quality of the machine translation of the sequence from the first language to the second language.

54. The apparatus according to claim 35, wherein a configuration of a machine translation engine to translate the first machine translation is different than a configuration of a machine translation engine to translate the second machine translation.

55. The apparatus according to claim 35, wherein a configuration of a machine translation engine to translate the first machine back translation is different than a configuration of a machine translation engine to translate the second machine back translation.

56. The apparatus according to claim 35, wherein the apparatus is further configured to extract data from the sequence of natural language data in a first language and to compute a comparison data according to the extracted data, and wherein the apparatus is further configured to combine the data of the comparisons.

57. The apparatus according to claim 35, wherein the apparatus is configured to categorise the translation of the sequence of natural language data in response to said signal.

58. The apparatus according to claim 57, wherein the categorisation is configured to represent a level of quality of the machine translation.

59. The apparatus according to claim 35, wherein the apparatus is configured to perform various translations, and various back translations, and to compare various machine translations and back translations respectively.

60. The apparatus according to claim 35, wherein the apparatus is further configured to translate the sequence of natural language data to a third language, and further configured to translate the sequence in the third language to the second language to define the first machine translation of the sequence of natural language.

61. The apparatus according to claim 35, wherein the apparatus is configured to output said signal to a user online, when the user inputs the sequences of natural language online into the apparatus.

62. The apparatus according to claim 35, wherein the apparatus is further being configured to simplify the sequence of natural language in the first language before translating the sequence.

63. The apparatus according to claim 35, wherein the apparatus is being configured to receive customization for the machine translation or the machine back translation so that a certain word is translated in a certain way.

64. The apparatus according to claim 63, wherein the apparatus is further being configured to output a confidence estimate to illustrate whether the customized translation was translated well.

65. A method, comprising:
receiving a sequence of natural language data in a first language;
translating the sequence of natural language data to a second language to define a first machine translation of the sequence of natural language data;
translating the sequence of natural language data to the second language to define a second machine translation of the sequence of natural language data;
back translating the sequence of natural language data of the first machine translation to the first language to define a first machine back translation of the sequence of natural language data;
back translating the sequence of natural language data of the first machine translation to the first language to define a second machine back translation of the sequence of natural language data;
computing a comparison based on the sequence of natural language data in the first language, the first machine translation of the sequence of natural language data, the second machine translation of the sequence of natural language data, the first machine back translation of the sequence of natural language data, and the second machine back translation of the sequence of natural language data; and
outputting a signal representative of the comparison.

66. A computer program, comprising: programmable software codes configured to cause the program to receive a sequence of natural language data in a first language;
translate the sequence of natural language data to a second language to define a first machine translation of the sequence of natural language data;
translate the sequence of natural language data to the second language to define a 30 second machine translation of the sequence of natural language data;
back translate the sequence of natural language data of the first machine translation to the first language to define a first machine back translation of the sequence of natural language data;
back translate the sequence of natural language data of the first machine translation to the first language to define a second machine back translation of the sequence of natural language data;
compute a comparison based on the sequence of natural language data in the first language, the first machine translation of the sequence of natural language data, the second machine translation of the sequence of natural language data, the first machine back translation of the sequence of natural language data, and the second machine back translation of the sequence of natural language data; and
output a signal representative of the comparison.
